(19) United States
(12) Patent Application Publication
(10) Pub. No.: US 2026/0029030 A1
(43) Pub. Date: Jan. 29, 2026

(54) FRICTION PAIR

(71) Applicant: NISSHINBO BRAKE, INC., TOKYO (JP)

(72) Inventors: Sota FUNAMOTO, GUNMA-KEN (JP); Kenta KURIMOTO, GUNMA-KEN (JP)

(73) Assignee: NISSHINBO BRAKE, INC., TOKYO (JP)

(21) Appl. No.: 19/348,806

(22) Filed: Oct. 3, 2025

Related U.S. Application Data
(63) Continuation-in-part of application No. 18/009,724, filed on Dec. 10, 2022.

(51) Int. Cl. F16D 65/092; F16D 65/02

(52) U.S. Cl. CPC F16D 65/092; F16D 2065/1324; F16D 2200/0052

(57) ABSTRACT

A friction pair including a disc brake pad and a stainless steel disc rotor is provided. The disc brake pad has a friction material composition including a binder, a fiber base material, and a friction modifier and excluding a copper component and any metallic fiber. The friction material composition includes 1-6 weight % trimanganese tetraoxide as an inorganic friction modifier and 1-10 weight % graphite, all relative to the total amount of the friction material composition. The trimanganese tetraoxide reduces to manganese during braking, depositing on the stainless steel rotor to toughen the surface and prevent tear-off or lumping, and the graphite promotes this reduction while also serving as a lubricant.

### CROSS-REFERENCE TO RELATED APPLICATIONS

This application is a Continuation-in-Part of U.S. patent application Ser. No. 18/009,724, filed on Dec. 10, 2022, which is a national stage application under 35 U.S.C. § 371 of International Patent Application No. PCT/JP2021/021879, filed on Jun. 9, 2021, which claims priority to Japanese Patent Application No. 2020-103801, filed on Jun. 16, 2020. The entire disclosures of the above applications are incorporated herein by reference in their entireties.

### BACKGROUND OF THE INVENTION

### Field of Invention

The present invention relates to a friction pair, and more particularly to a friction pair for use in vehicles such as passenger cars.

### Description of the Related Arts

Conventionally, disc brake pads having a friction material affixed to a metal backing plate have been widely used as friction members in disc brakes for passenger cars.

In recent years, as demands for quieter braking have increased, disc brake pads employing non-asbestos organic (NAO) friction materials, which generate less brake noise, have come into widespread use.

NAO friction materials are manufactured from a friction material composition including a binder and a fiber base material other than steel-based fibers, such as steel fibers or stainless steel fibers. NAO friction materials are classified as one type of friction material alongside semi-metallic friction materials and low-steel friction materials, which do include steel-based fibers as the fiber base material. More recently, due to regulations in the United States restricting the amount of copper permitted in friction materials, compositions containing 5 weight % or less of copper, or no copper at all, have become increasingly common.

Patent Document 1 (Japanese Provisional Patent Publication No. 2017-57312) discloses a friction material composition containing a fiber base material, a friction modifier, and a binder. The composition includes a copper component of 0.5 weight % or less, based on the copper element, and further contains a granular titanate obtained by granulating titanate. The granular titanate has an average particle diameter of 100-250 μm. Patent Document 1 also discloses a friction material formed from such a composition.

Patent Document 2 (Japanese Provisional Patent Publication No. 2018-162385) discloses a friction material composition containing a fiber base material, an inorganic filler, an organic filler, and a binder. The composition includes 0.5 weight % or less of copper. As part of the inorganic filler, the composition further contains abrasives having average particle diameters of 3-5 μm and 9-13 μm. In addition, as another part of the inorganic filler, the composition contains titanates having average particle diameters of 1.5-4.5 μm and 15-45 μm.

As a mating member for disc brake pads using such friction materials containing little or no copper, cast iron disc rotors, as disclosed in Patent Document 3 (Japanese Provisional Patent Publication No. 1990-134425), have been employed. However, cast iron disc rotors exhibit low corrosion resistance and tend to rust during use, creating the need for countermeasures in the friction material to address this problem.

For example, Patent Document 4 (Japanese Provisional Patent Publication No. 2017-149971) discloses a friction material containing a binder, a friction modifier, and a fiber base material. The material improves the descaling performance of the mating member by including no copper component, 10-20 volume % of at least one type of titanate compound having multiple projections, and 1-20 volume % of a biosoluble inorganic fiber, each relative to the total amount of the friction material composition.

However, with the adoption of regenerative braking in electric and hybrid vehicles, the load applied to the friction material by conventional hydraulic braking is reduced. As a result, even the technology disclosed in Patent Document 4 does not provide sufficient descaling performance.

Accordingly, stainless steel disc rotors, which offer superior rust resistance, have come into common use.

Patent Document 5 (Japanese Provisional Patent Publication No. 2016-117925) discloses a disc rotor for a four-wheel vehicle manufactured from a stainless steel plate. The rotor has either a martensitic structure or a mixed structure of martensitic and ferritic phases.

Patent Document 6 (Japanese Provisional Patent Publication No. 2019-173086) discloses a disc rotor for an automobile having a structure that contains martensite and carbonitride, and selectively contains ferrite.

Patent Document 7 (Japanese Provisional Patent Publication No. 2019-178419) discloses a disc rotor for an automobile made of a stainless steel plate that includes C: 0.005-0.100%, Si: 0.01-1.00%, Mn: 0.010-3.00%, P: 0.040% or less, S: 0.0100% or less, Cr: 10.0-14.0%, N: 0.005-0.100%, V: 0.03-0.30%, Al: 0.001-0.050%, B: 0.0002-0.0050%, Ni: 0-2.00%, Cu: 0-2.00%, Mo: 0-1.00%, W: 0-1.00%, Ti: 0-0.40%, Nb: 0-0.40%, Zr: 0-0.40%, Co: 0-0.400%, Sn: 0-0.40%, REM: 0-0.050% or less, Mg: 0-0.0100%, Ca: 0-0.0100%, Sb: 0-0.50%, Ta: 0-0.3000%, Hf: 0-0.3000%, and Ga: 0-0.1000%, and the remaining substances are Fe and impurities, where a metal structure is made of a ferrite phase and 10-50 particles per 100 μm2 of carbonitride with 0.3 μm or more of equivalent circle diameter exists at an arbitrary cross section thereof.

In view of the above-described background, there has been demand for a friction material that contains no copper component and is suitable for use with stainless steel disc rotors having superior rust resistance. However, stainless steel rotors are prone to significant thermal expansion and plastic deformation. When exposed to high temperatures, the rotor surface tends to tear off, leading to the formation of metallic lumps originating from the rotor material itself.

Patent Document 8 (U.S. Patent Application Publication No. 2004/0241429) discloses a friction material composition for use with cast iron disc rotors. The disclosed composition includes trimanganese tetroxide (Mn₃O₄) in order to improve fade resistance without lowering the coefficient of friction. The document explains that trimanganese tetroxide undergoes structural changes at elevated temperatures, contributing to noise suppression and stabilization of the friction coefficient in cast iron rotor systems.

However, such technology is directed to cast iron rotors, which differ significantly from stainless steel rotors in thermal conductivity, corrosion resistance, and deformation behavior. As a result, the mechanisms described in Patent Document 8 do not address the unique problems of stainless steel rotors, such as surface tear-off and metallic lump formation under high-temperature braking. Therefore, there remains a need for a friction material composition specifically adapted for stainless steel disc rotors.

### SUMMARY OF THE INVENTION

This invention provides a friction pair capable of inhibiting the formation of metallic lumps on a friction surface of a disc rotor. The friction pair has a stainless steel disc rotor and a disc brake pad including a friction material composition that contains a binder, a fiber base material, and a friction modifier, while excluding copper components and containing no metallic fibers.

The inventors of the present invention, after extensive investigation, discovered that in a friction pair having a disc brake pad and a stainless steel disc rotor, the formation of metallic lumps on the rotor friction surface can be effectively inhibited. The disc brake pad is manufactured from a friction material composition containing a binder, a fiber base material, and a friction modifier, while excluding copper components and containing no metallic fibers. By incorporating 1-6 weight % of trimanganese tetraoxide (Mn₃O₄), relative to the total amount of the friction material composition, as an inorganic friction modifier, stable braking performance can be achieved without lump formation on the stainless steel rotor surface.

This invention relates to a friction pair comprising a disc brake pad and a stainless steel disc rotor. The disc brake pad is manufactured from a friction material composition containing a binder, a fiber base material, and a friction modifier, while excluding copper components and containing no metallic fibers. The invention is further based on the following technology.

According to the present invention, the friction pair has a stainless steel disc rotor; and a disc brake pad including a friction material manufactured from a friction material composition. The friction material composition includes a binder, a fiber base material, and a friction modifier but excludes copper components and metallic fibers. The friction material composition contains 1-6 weight % of a trimanganese tetraoxide (Mn₃O₄) as an inorganic friction modifier and 1-10 weight % of graphite as a lubricant, each relative to the total weight of the friction material composition. Under braking against the stainless steel rotor, the graphite promotes reduction of the trimanganese tetraoxide to manganese, and the manganese deposits on the stainless steel rotor surface to increase toughness of the rotor surface and suppress plastic deformation, rotor surface tear-off, and metallic lump formation.

The friction material composition can include the graphite containing at least one selected from artificial graphite, natural graphite, or pulverized graphite sheet powder and can include the manganese deposited on the stainless steel rotor surface forms a protective layer that prevents adhesion of rotor-originated metallic lumps. The graphite additionally functions as a solid lubricant to stabilize braking performance over repeated thermal cycles. The friction material composition can include an organic filler or inorganic filler selected from titanates, silicates, or zirconates, other than the trimanganese tetraoxide.

In the present invention, the stainless steel disc rotor can include a martensitic stainless steel or a mixed microstructure including martensite and ferrite phases and the braking system is installed in an electric vehicle or hybrid vehicle equipped with regenerative braking, where the friction pair provides enhanced braking stability under reduced hydraulic braking loads.

Unless otherwise stated, all percentages are expressed as weight % relative to the total weight of the friction material composition. Particle sizes refer to average particle diameter, and all units are expressed in SI. The term “metallic fibers” as used herein includes both ferrous-based and non-ferrous metallic fibers. The specified ranges for individual components are independent preferred ranges and may be adjusted such that the total of all components equals 100 weight %. The recited amount of graphite is counted within the lubricant fraction, and the recited amount of trimanganese tetraoxide is included within the total inorganic friction modifier fraction.

### EMBODIMENTS FOR CARRYING OUT THE INVENTION

A stainless steel disc rotor exhibits lower thermal conductivity and thermal diffusivity than a cast iron disc rotor. Stainless steel also has a slightly higher specific gravity but greater strength compared with cast iron. Therefore, to achieve substantially the same specific gravity and strength as a cast iron disc rotor, the stainless steel rotor is typically made thinner. As a result, the heat capacity of the stainless steel disc rotor is reduced, and heat tends to accumulate, thereby raising the temperature of the friction material during braking.

Furthermore, stainless steel has a high degree of elongation, making it more susceptible to plastic deformation. When the rotor temperature rises, the rotor surface may tear off, resulting in the formation of metallic lumps originating from the rotor material. These metallic lumps accelerate abnormal wear of the friction material, and therefore a technology for suppressing such lump formation has been in demand.

In view of these problems, the present invention provides a friction pair comprising a stainless steel disc rotor and a disc brake pad manufactured from a friction material composition containing a binder, a fiber base material, and a friction modifier, while excluding copper components and metallic fibers. The friction material composition further includes 1-6 weight % of trimanganese tetraoxide (Mn₃O₄) as an inorganic friction modifier.

Under frictional heat, the trimanganese tetraoxide undergoes reduction to manganese. The generated manganese deposits on the stainless steel rotor surface, enhancing surface toughness, suppressing plastic deformation, and inhibiting both rotor surface tear-off and metallic lump formation.

The effect is further improved by adding 1-10 weight % of graphite, relative to the total weight of the friction material composition. Suitable forms include artificial graphite, natural graphite, or pulverized graphite sheet powder. The graphite accelerates the reduction of trimanganese tetraoxide, thereby increasing the extent of manganese deposition on the rotor surface and improving resistance against lump formation and adhesion failures.

Unlike conventional friction materials where manganese oxides or graphite function mainly to stabilize the pad itself or reduce fade, in the present invention these constituents act directly at the rotor interface. Through in-situ manganese deposition and graphite-promoted reduction, the stainless steel rotor surface is strengthened and protected against high-temperature damage.

The synergistic behavior of graphite is particularly important. Beyond its conventional role as a solid lubricant, graphite promotes the reduction of trimanganese tetraoxide, resulting in greater manganese deposition on the rotor surface. This dual functionality-chemical promotion and lubrication-ensures rotor surface stability under repeated braking cycles and high thermal loads.

In conventional friction materials intended for cast iron rotors, such as those described in the related art, trimanganese tetraoxide have been employed primarily to improve fade resistance by stabilizing the friction coefficient at elevated temperatures. Such effects are achieved by internal oxygen adsorption or changes in hardness of the oxide itself. However, these mechanisms act within the friction material and do not directly address the deformation characteristics of a stainless steel rotor. Accordingly, such teachings are insufficient to suppress surface tear-off or metallic lump formation that are unique to stainless steel rotor systems.

Similarly, while graphite has been widely used in conventional compositions as a solid lubricant to reduce friction or stabilize braking characteristics, its role has been limited to internal lubrication of the pad material. In contrast, in the present invention, graphite functions as a reduction promoter for trimanganese tetraoxide, thereby actively facilitating manganese deposition onto the stainless steel rotor surface. This dual mechanism—promotion of reduction chemistry and conventional lubrication—is not disclosed or suggested in conventional compositions designed for cast iron rotors.

Thus, the present invention introduces a rotor-surface-oriented mechanism fundamentally distinct from conventional teachings. By combining trimanganese tetraoxide and graphite in the specified proportions, the invention enables in-situ reinforcement of the stainless steel rotor surface, addressing failure modes such as tear-off and metallic lump formation that are not encountered in cast iron rotor systems. This unique mechanism clearly distinguishes the invention from prior friction material technologies developed for use with cast iron rotors.

These effects are especially advantageous in modern electric and hybrid vehicles. Because regenerative braking reduces the hydraulic brake load, rotor surfaces experience less self-cleaning and greater heat accumulation. Under such conditions, conventional friction materials fail to prevent adhesion and surface damage, whereas the present invention provides stable braking by actively reinforcing the stainless steel rotor surface.

Accordingly, the present invention delivers a rotor-specific solution for stainless steel disc rotor systems. By combining trimanganese tetraoxide and graphite in the specified ranges, the invention prevents metallic lump formation, suppresses rotor tear-off, and maintains reliable braking performance where conventional cast iron-based materials are inadequate.

### <Friction Material Composition>

The friction material used in the friction pair of the present invention is manufactured from a friction material composition that includes a binder, a fiber base material, and a friction modifier, together with the above-described trimanganese tetraoxide and graphite.

As the binder, any of the binders generally used for friction materials may be employed. Examples include straight phenolic resin; acrylic rubber-modified phenolic resin; silicone rubber-modified phenolic resin; nitrile rubber (NBR)-modified phenolic resin; cashew nut shell liquid (CNSL)-modified phenolic resin; aralkyl-modified phenolic resin (phenol-aralkyl resin) obtained by reacting a phenol compound, an aralkyl ether compound, and an aldehyde compound; acrylic rubber-dispersed phenolic resin; silicone rubber-dispersed phenolic resin; and fluoropolymer-dispersed phenolic resin. A combination of two or more of these binders may also be used.

The binder is preferably contained in an amount of 4-9 weight % relative to the total weight of the friction material composition, and more preferably in an amount of 6-8 weight % relative to the total weight of the friction material composition.

As the fiber base material, any of the fibers generally used in friction materials may be employed. Examples include aramid fibers, acrylic fibers, cellulose fibers, and poly(p-phenylene-2,6-benzobisoxazole) (PBO) fibers. A combination of two or more of these fiber base materials may also be used.

The fiber base material is preferably contained in an amount of 1-5 weight % relative to the total weight of the friction material composition, and more preferably in an amount of 2-4 weight % relative to the total weight of the friction material composition.

As the friction modifier, a lubricant, an inorganic friction modifier, or an organic friction modifier may be used.

As the lubricant, either a carbon-based lubricant or a metal sulfide lubricant may be used, or a combination of two or more thereof. Examples of carbon-based lubricants include artificial graphite, natural graphite, pulverized graphite sheet powder, petroleum coke, coal coke, resilient graphitic carbon, and pulverized polyacrylonitrile oxide fiber. Examples of metal sulfide lubricants include tin sulfide, molybdenum disulfide, iron sulfide, bismuth sulfide, zinc sulfide, and composite metal sulfides.

The lubricant, in addition to the above-described graphite, is preferably contained in an amount of 10-18 weight % relative to the total weight of the friction material composition, and more preferably in an amount of 11-16 weight % relative to the total weight of the friction material composition.

As the inorganic friction modifier, in addition to the above-described trimanganese tetraoxide, any of the following may be used, alone or in combination of two or more: calcium hydroxide, calcium carbonate, barium sulfate, talc, dolomite, zeolite, triiron tetroxide, calcium silicate hydrate, magnesium oxide, silicon dioxide, zirconium oxide, zirconium silicate, γ-alumina, α-alumina, silicon carbide, columnar titanate, platy titanate, particulate titanate, squamous titanate, or titanates having multiple projections, such as potassium titanate, lithium potassium titanate, magnesium potassium titanate, and sodium titanate, as well as wollastonite, sepiolite, basalt fiber, glass fiber, biosoluble ceramic fiber, and rock wool.

The inorganic friction modifier, together with the above-described trimanganese tetraoxide, is preferably contained in an amount of 60-82 weight % relative to the total weight of the friction material composition, and more preferably in an amount of 65-76 weight % relative to the total weight of the friction material composition.

As the organic friction modifier, any of the organic materials generally used in friction materials may be employed, alone or in combination of two or more. Examples include cashew dust, pulverized tire tread rubber, polytetrafluoroethylene (PTFE) powder, and various rubbers, either vulcanized or unvulcanized, such as acrylic rubber, isoprene rubber, nitrile butadiene rubber (NBR), styrene-butadiene rubber (SBR), butyl rubber, and silicone rubber.

The organic friction modifier is preferably contained in an amount of 3-8 weight % relative to the total weight of the friction material composition, and more preferably in an amount of 5-7 weight % relative to the total weight of the friction material composition.

### <Manufacturing Method for Disc Brake Pad>

The disc brake pad of the present invention is typically manufactured through the following steps. First, a mixing step is carried out in which predetermined amounts of the friction material composition are uniformly mixed in a mixer to obtain a raw friction material mixture. Next, in a heat press forming step, the raw friction material mixture is placed on a prewashed, surface-treated, and adhesive-coated back plate within a heat forming die and heat-pressed to form a press-molded article. In a subsequent heating step, the press-molded article is heated to cure the binder, thereby obtaining a cured article. The cured article then undergoes a coating step, such as spray coating or electrostatic powder coating, followed by a baking step in which the coating is baked to produce a baked article. Finally, in a grinding step, the baked article is ground with a rotary grinder to form a friction surface. Optionally, after the heat press forming step, the pad may be subjected to a heat treatment step consisting of the coating and baking steps, followed by the grinding step.

Also, as appropriate, prior to the heat press forming step, a granulating step for granulating the raw friction material mixture, a kneading step for kneading the raw friction material mixture, and a pre-forming step for forming a pre-formed article by positioning the raw friction material mixture or the granulated article obtained through the granulating step or the kneaded article obtained through the kneading step, may be performed, and a scorching step may be performed after the heat press forming step.

### <Stainless Steel Disc Rotor>

As the stainless steel disc rotor, for example, a martensite type stainless steel disc rotor or a ferrite type stainless steel disc rotor may be used.

The friction pair of the present invention thus achieves effects not obtainable with conventional cast iron rotor technologies. Whereas cast iron rotors inherently differ in thermal conductivity, deformation characteristics, and corrosion resistance, the present invention provides a composition specifically adapted to stainless steel rotors. Through the reduction of trimanganese tetraoxide and the synergistic action of graphite, the stainless steel rotor surface is reinforced in situ, preventing tear-off and metallic lump formation even under severe thermal loads. As a result, the invention ensures reliable braking stability, long service life, and suitability for modern vehicles, including electric and hybrid vehicles where regenerative braking alters thermal and tribological conditions.

### EMBODIMENTS

This invention is explained concretely using the Embodiments and the Comparative Examples of this invention in the following sections; however, this invention is not limited to the following Embodiments.

### <Manufacturing Method for the Friction Material According to Embodiments 1-11 and Comparative Examples 1-2>

The friction material composition shown in Table 1 is positioned in the Loedige mixer to be mixed for about 5 minutes and is pressed in a pre-forming die under 30 MPa for about 10 seconds to obtain the pre-formed article. The pre-formed article is superposed on the steel back plate, which is pre-washed, surface treated, and adhesive coated, to be heat-pressed in the heat forming die at 150 centigrade under the forming pressure of 40 MPa for about 10 minutes, then the heat treatment (postcure treatment) at 200 centigrade is performed for about 5 hours, and the grinding step is performed to form the friction surface, thereby obtaining the disc brake pad for a passenger car.

TABLE 1

| | | | | | | | | | | | | | | | comparative | |
|---|---|---|---|---|---|---|---|---|---|---|---|---|---|---|---|---|
| | | | | embodiments | | | | | | | | | | | examples | |
| | | | | 1 | 2 | 3 | 4 | 5 | 6 | 7 | 8 | 9 | 10 | 11 | 12 | 13 |
| binder | | | straight phenol resin | 7.0 | 7.0 | 7.0 | 7.0 | 7.0 | 7.0 | 7.0 | 7.0 | 7.0 | 7.0 | 7.0 | 7.0 | 7.0 |
| fiber base | | | aramid fiber | 3.0 | 3.0 | 3.0 | 3.0 | 3.0 | 3.0 | 3.0 | 3.0 | 3.0 | 3.0 | 3.0 | 3.0 | 3.0 |
| friction | lubricant | carbonaceous | graphite sheet | 6.0 | 6.0 | 6.0 | 6.0 | 6.0 | 0.5 | 1.0 | 4.0 | 8.0 | 10.0 | 11.0 | 6.0 | 6.0 |
| modifier | | lubricants | pulverized powder | 5.0 | 5.0 | 5.0 | 5.0 | 5.0 | 10.5 | 10.0 | 7.0 | 3.0 | 1.0 | 1.0 | 5.0 | 5.0 |
| | | | petroleum coke | | | | | | | | | | | | | |
| | | metal sulfide | zinc sulfide | 1.0 | 1.0 | 1.0 | 1.0 | 1.0 | 1.0 | 1.0 | 1.0 | 1.0 | 1.0 | 1.0 | 1.0 | 1.0 |
| | | lubricants | | | | | | | | | | | | | | |

| | | | | | | | | | | | | | | |
|---|---|---|---|---|---|---|---|---|---|---|---|---|---|---|
| inorganic friction | zirconium oxide | 20.0 | 20.0 | 20.0 | 20.0 | 20.0 | 20.0 | 20.0 | 20.0 | 20.0 | 20.0 | 20.0 | 20.0 | 20.0 |
| modifier | zirconium silicate | 1.0 | 1.0 | 1.0 | 1.0 | 1.0 | 1.0 | 1.0 | 1.0 | 1.0 | 1.0 | 1.0 | 1.0 | 1.0 |
| | magnesium oxide | 1.0 | 1.0 | 1.0 | 1.0 | 1.0 | 1.0 | 1.0 | 1.0 | 1.0 | 1.0 | 1.0 | 1.0 | 1.0 |
| | trimanganese | 1.0 | 2.0 | 3.0 | 5.0 | 6.0 | 3.0 | 3.0 | 3.0 | 3.0 | 3.0 | 3.0 | 0.5 | 7.0 |
| | tetroxide | | | | | | | | | | | | | |
| | lithium potassium | 22.0 | 22.0 | 22.0 | 22.0 | 22.0 | 20.0 | 20.0 | 20.0 | 20.0 | 20.0 | 20.0 | 22.0 | 22.0 |
| | titanate | | | | | | | | | | | | | |
| | calcium hydroxide | 3.0 | 3.0 | 3.0 | 3.0 | 3.0 | 3.0 | 3.0 | 3.0 | 3.0 | 3.0 | 3.0 | 3.0 | 3.0 |
| | barium sulfate | 24.0 | 23.0 | 22.0 | 20.0 | 19.0 | 24.0 | 24.0 | 24.0 | 24.0 | 24.0 | 23.0 | 24.5 | 18.0 |
| organic friction | cashew dust | 4.0 | 4.0 | 4.0 | 4.0 | 4.0 | 4.0 | 4.0 | 4.0 | 4.0 | 4.0 | 4.0 | 4.0 | 4.0 |
| modifier | tire tread rubber | 2.0 | 2.0 | 2.0 | 2.0 | 2.0 | 2.0 | 2.0 | 2.0 | 2.0 | 2.0 | 2.0 | 2.0 | 2.0 |
| | pulverized powder | | | | | | | | | | | | | |

| | | | | | | | | | | | | | |
|---|---|---|---|---|---|---|---|---|---|---|---|---|---|
| total | 100.0 | 100.0 | 100.0 | 100.0 | 100.0 | 100.0 | 100.0 | 100.0 | 100.0 | 100.0 | 100.0 | 100.0 | 100.0 |

Furthermore, test pieces of the Embodiments 1-11 and the Comparative Examples 1-2 are prepared by cutting the friction material for the disc brake pad into 25 mm×15 mm×15 mm pieces

Table 2 shows the “Testing Condition”, “Material of Mating Member”, “Evaluation Items”, and “Evaluation Standard” used to examine the formation of the lump of the metal on the disc rotor friction surface and the stability of the braking effect.

TABLE 2

| | | forming a metal lump on | |
|---|---|---|---|
| | | a disc rotor friction surface | stability of braking effectiveness |
| testing condition | | based on JASO C406 friction | based on JASO C406 friction |
| | | tester (1/10 scale tester) | tester (1/10 scale tester) |
| material of the | | martensitic stainless steel | martensitic stainless steel |
| mating member | | | |
| evaluation Items | | existence or non-existence and size | changes relative to μ level |
| | | of metal lump on the surface of the | of the base material × cast iron |
| | | mating member after JASO-C406 | at JASO-C406 friction testing |
| | | friction material abrasion testing | |
| evaluation | E | no metal lump | 0.38 with tolarence of less than ±5% |
| Standard | G | metal lump (less than 0.5 mm) | 0.38 with tolerance of more |
| | | | than ±5% but less than ±10% |
| | P | metal lump (0.5 mm or | 0.38 with tolerance of ±10% |
| | | more but less than 1 mm) | or more but less than ±15% |
| | F | metal lump (1 mm or more) | 0.38 with tolerance of ±15% or more |

Table 3 shows the evaluation result of the respective Embodiments and Comparative Examples with respect to the formation of the lump of the metal on the disc rotor friction surface and the stability of the braking effect shown in the Table 2.

TABLE 3

| | | | | | | | | | | | | | comparative | |
|---|---|---|---|---|---|---|---|---|---|---|---|---|---|---|
| | | embodiments | | | | | | | | | | | examples | |
| | | 1 | 2 | 3 | 4 | 5 | 6 | 7 | 8 | 9 | 10 | 11 | 12 | 13 |
| evaluation result | forming a metal lump on a disc | P | G | E | E | E | P | G | E | E | E | E | F | E |
| | rotor friction surface | | | | | | | | | | | | | |
| | stability of braking effectiveness | E | E | E | E | P | E | E | E | E | G | P | E | F |

E = excellent
G = good
P = pass
F = fail

From the Table 3, it can be seen that the friction material satisfying the conditions of this invention inhibits the formation of the lump of the disc rotor friction surface and provides the stability in the braking effect.

Accordingly, the present invention provides a friction pair comprising a disc brake pad, manufactured from a friction material composition containing a binder, a fiber base material, and a friction modifier, while excluding copper components and metallic fibers, together with a stainless steel disc rotor. This friction pair inhibits the formation of metallic lumps on the rotor friction surface, ensures excellent stability of braking performance, and offers high practical value.

What is claimed is:

1. A friction pair, comprising:
a stainless steel disc rotor; and
a disc brake pad including a friction material manufactured from a friction material composition containing a binder, a fiber base material, and a friction modifier, the friction material composition excluding copper components and metallic fibers,
wherein the friction material composition comprises 1-6 weight % of a trimanganese tetraoxide (Mn₃O₄) as an inorganic friction modifier and 1-10 weight % of graphite as a lubricant, each relative to the total weight of the friction material composition,
wherein, under braking against the stainless steel rotor, the graphite promotes reduction of the trimanganese tetraoxide to manganese, and the manganese deposits on the stainless steel rotor surface to increase toughness of the rotor surface and suppress plastic deformation, rotor surface tear-off, and metallic lump formation.

2. The friction pair of claim 1,
wherein the graphite comprises at least one selected from artificial graphite, natural graphite, or pulverized graphite sheet powder.

3. The friction pair of claim 1,
wherein the manganese deposited on the stainless steel rotor surface forms a protective layer that prevents adhesion of rotor-originated metallic lumps.

4. The friction pair of claim 1,
wherein the stainless steel disc rotor comprises a martensitic stainless steel or a mixed microstructure including martensite and ferrite phases.

5. The friction pair of claim 1,
wherein the braking system is installed in an electric vehicle or hybrid vehicle equipped with regenerative braking, and the friction pair provides enhanced braking stability under reduced hydraulic braking loads.

6. The friction pair of claim 1,
wherein the graphite additionally functions as a solid lubricant to stabilize braking performance over repeated thermal cycles.

7. The friction pair of claim 1,
wherein the disc brake pad further includes an organic filler or inorganic filler selected from titanates, silicates, or zirconates, other than the trimanganese tetraoxide.

8. A friction material composition for use in a disc brake pad of a stainless steel disc rotor, the composition comprising a binder, a fiber base material, and a friction modifier, the composition containing no copper components and no metallic fibers,
wherein the friction material composition comprises 1-6 weight % trimanganese tetraoxide and 1-10 weight % graphite, each relative to the total weight of the composition,
wherein, under braking against the stainless steel rotor, the graphite promotes reduction of the trimanganese tetraoxide to manganese, and the manganese deposits on the rotor surface to increase rotor surface toughness, suppress rotor surface tear-off, and prevent metallic lump formation.

9. The friction material composition of claim 8,
wherein the graphite comprises at least one selected from artificial graphite, natural graphite, or pulverized graphite sheet powder.

10. The friction material composition of claim 8,
wherein the binder comprises at least one thermosetting resin selected from phenolic resins, epoxy resins, and modified phenolic resins.

11. The friction material composition of claim 8,
wherein the fiber base material comprises at least one selected from aramid fibers, organic fibers, ceramic fibers, and glass fibers.

12. The friction material composition of claim 8,
wherein the graphite is present in an amount effective to accelerate the reduction of trimanganese tetraoxide during braking and thereby enhance manganese deposition on the stainless steel rotor surface.

13. The friction material composition of claim 8,
further comprising an organic filler or inorganic filler selected from titanates, silicates, or zirconates, other than the trimanganese tetraoxide.

14. The friction material composition of claim 8,
wherein the composition provides stable braking performance in an electric or hybrid vehicle equipped with regenerative braking.
